(19) United States
(12) Patent Application Publication
(10) Pub. No.: US 2011/0081510 A1
(43) Pub. Date: Apr. 7, 2011

(54) MELT STRENGTH ENHANCED COPOLYESTER WITH IMPROVED STABILITY AND PROFILE IN BLOWN FILM

(75) Inventors: Wayne Ken Shih, Kingsport, TN (US); Rondell Paul Little, JR., Johnson City, TN (US); Freddie Wayne Williams, Kingsport, TN (US)

(73) Assignee: EASTMAN CHEMICAL COMPANY, Kingsport, TN (US)

(21) Appl. No.: 12/862,354

(22) Filed: Aug. 24, 2010

Related U.S. Application Data
(60) Provisional application No. 61/249,410, filed on Oct. 7, 2009.

(51) Int. Cl. B65B 53/00; B29C 49/04; B32B 1/08; B32B 27/36; C08G 63/183; C08G 63/189

(52) U.S. Cl. 428/34.9; 264/564; 528/308.6; 528/308

(57) ABSTRACT

The invention relates to blown films and methods of making blown films using a melt-strength enhanced polyester composition. The composition has a zero-shear viscosity and a degree of shear thinning that are comparable to PVC's melt rheology. The polyester composition has a branching agent and/or a fluoropolymer processing additive and an inherent viscosity of at least 0.60 dl/g. The diacid component of the polyester composition comprises 97 to 100 mole percent of residues of terephthalic acid, naphthalenedicarboxylic acid, isophthalic acid or mixtures thereof. The glycol component of the polyester composition comprises 97 to 100 mole percent of residues of ethylene glycol, 1,4-cyclohexanedimethanol, diethylene glycol, neopentyl glycol or mixtures thereof.

### CROSS REFERENCE TO RELATED APPLICATIONS

This application claims benefit of the provisional application U.S. Ser. No. 61/249,410 filed Oct. 7, 2009.

### FIELD OF THE INVENTION

The present invention generally relates to the field of blown films and methods of making blown films.

### BACKGROUND OF THE INVENTION

A blown film process is commonly used to manufacture bags and films for packaging. Polymers such as polyvinyl chloride (PVC), polyethylene (PE), and polypropylene (PP) are typically used as blown film materials.

For low-cost shrink film applications such as tamper-resistant bands and shrink sleeves, a double-bubble blown film line is the predominant choice because it is much less capital intensive than an extrusion/tentering line. However, the blown PVC shrink film has been under intensified environmental scrutiny. As a result, a more environmentally friendly polymer is desired to replace PVC.

Since copolyesters have gained significant acceptance as a substitute in the transverse direction oriented (TDO) PVC shrink film market, it seems logical that copolyesters should be used to substitute PVC in blown PVC shrink film applications. However, producing an acceptable copolyester shrink film utilizing the existing PVC blown film lines has proven to be very difficult. Copolyesters have lower melt strength and insufficient shear thinning—resulting in poor bubble stability at high melt temperatures and melt fracture (hazy) at low melt temperatures. Both melt strength and shear thinning are important properties in determining if a polyester can be used as a drop-in replacement for PVC in an existing blown film line, since the existing line was designed to take advantage of PVC's properties, which are high melt strength and good shear thinning.

In addition to other properties such as clarity and gel-free, etc., excellent profile and consistent shrinkage are arguably two of the most important requirements for a shrink film. Bubble stability for the first bubble, second bubble, even the third bubble is another key parameter for good gauge/profile and consistent shrinkage in the blown film. Bubble stability without any structural assistance is preferred even though some blown film lines are equipped with sizing rings and optional bubble stabilizing cages.

Melt strength is defined as the ability of a polymer to support its weight in the molten state. In a blown film process, the polymer can be extruded vertically upward/downward, or horizontally forward from a die which can be a spider, side-fed manifold, or spiral mandrel type. In such a process, a polymer with low melt strength will quickly sag while a polymer with high melt strength will maintain its tubular shape. Melt strength, in percentage, can be measured by a standard test method described in U.S. Pat. No. 4,398,022. Typical melt strengths for PVC under standard processing temperatures (160-200° C.) are on the order of 20 to 30%. Polyesters, on the other hand, may have a negative value for melt strength. For example, a glycol-modified polyethylene terephthalate (PETG), having an inherent viscosity (IV) of 0.76 dl/g, has a melt strength of −4% at 200° C. and −24% at 220° C.

A higher melt strength reduces bubble sagging/distortion, maintains steady tubular shape and thickness, promotes self leveling, prevents excessive thinning, and enhances profile distribution after stretching.

Melt strength depends primarily on the viscosity of the melt. For a polymer with low melt strength, it has to be melt-processed at lower than normal temperatures to boost its viscosity and hence its melt strength. However, at the lower temperatures, undesired gel formation due to insufficient heating and melt fracture due to high viscosity (hazy, rough film surface) are commonly seen in the stretched film. To overcome these two problems, a polymer having low shear thinning at a high shear rate is needed.

At very low shear rates, the viscosity is highest. This is referred to as the “zero-shear viscosity.” The zero-shear viscosity (along with the elasticity) defines the melt strength since the polymer is experiencing essentially a zero shear rate after exiting from the die. Thus, the higher the zero-shear viscosity, the higher the melt strength.

In the high shear rate region, the polymer is processed with shear rates in the die/extruder around 100 s⁻¹ in blown film. Polyesters, in general, have a very low degree of shear thinning relative to polymers like PVC and polyolefins. A low viscosity at high shear rates helps to minimize melt fracture in blown film. Melt fracture occurs when the wall shear stress in the die exceeds a certain value. The shear stress is a function of shear rate and the viscosity of the polymer melt.

An ideal polymer for blown film will have a high zero-shear viscosity with a high degree of shear thinning comparable to PVC. This maximizes melt strength while at the same time minimizes melt fracture and die pressures. This is particularly important for running polyesters in existing PVC machines, which are normally equipped with limited horsepower motors.

Thus, there is a need in the art for a polyester composition for use in making blown films that has enhanced melt strength to prevent bubble sagging and to improve bubble stability and material distribution with controlled shrinkage in both the machine direction (MD) and the transverse direction (TD). There is also a need for the polyester composition to have a high degree of shear thinning and be more user-friendly in melt processing by utilizing numerous existing blown film lines designed primarily for PVC. The present invention addresses these needs as well as others that will become apparent from the following description and claims.

### SUMMARY OF THE INVENTION

In one aspect, the invention relates to a blown film comprising at least one layer made from a polyester composition having an inherent viscosity of at least 0.60 dl/g. In one embodiment, the polyester composition comprises:

(a) a diacid component comprising 97 to 100 mole percent of residues of terephthalic acid, naphthalenedicarboxylic acid, isophthalic acid or mixtures thereof, based on the total mole percent of diacid residues in the polyester composition;

(b) a glycol component comprising 97 to 100 mole percent of residues of ethylene glycol, 1,4-cyclohexanedimethanol, diethylene glycol, neopentyl glycol or mixtures thereof, based on the total mole percent of glycol residues in the polyester composition; and

(c) 0.05 to 1.5 weight percent of a branching agent comprising at least three functional groups selected from hydroxyl, carboxyl, carboxylic anhydride, and mixtures thereof, based on the total weight of the polyester composition. In another embodiment, the polyester composition further comprises 100 to 2,000 ppm of a fluoropolymer processing additive, based on the total weight of the polyester composition.

In another embodiment, the polyester composition comprises:

(a) a diacid component comprising 97 to 100 mole percent of residues of terephthalic acid, naphthalenedicarboxylic acid, isophthalic acid or mixtures thereof, based on the total mole percent of diacid residues in the polyester composition;

(b) a glycol component comprising 97 to 100 mole percent of residues of ethylene glycol, 1,4-cyclohexanedimethanol, diethylene glycol, neopentyl glycol or mixtures thereof, based on the total mole percent of glycol residues in the polyester composition; and

(c) 100 to 2,000 ppm of a fluoropolymer processing additive, based on the total weight of the polyester composition.

In another aspect, the invention relates to a method of making a blown film. The method comprises:

(a) extruding a polyester composition through an annular die to form a tube; and

(b) inflating the inside of the tube with air to form a film bubble.

In one embodiment of the method, the polyester composition has an inherent viscosity of at least 0.60 dl/g and comprises:
(a) a diacid component comprising 97 to 100 mole percent of residues of terephthalic acid, naphthalenedicarboxylic acid, isophthalic acid or mixtures thereof, based on the total mole percent of diacid residues in the polyester composition;
(b) a glycol component comprising 97 to 100 mole percent of residues of ethylene glycol, 1,4-cyclohexanedimethanol, diethylene glycol, neopentyl glycol or mixtures thereof, based on the total mole percent of glycol residues in the polyester composition; and
(c) 0.05 to 1.5 weight percent of a branching agent comprising at least three functional groups selected from hydroxyl, carboxyl, carboxylic anhydride, and mixtures thereof, based on the total weight of the polyester composition.

In another embodiment of the method, the polyester composition has an inherent viscosity of at least 0.60 dl/g and comprises:
(a) a diacid component comprising 97 to 100 mole percent of residues of terephthalic acid, naphthalenedicarboxylic acid, isophthalic acid, or mixtures thereof based on the total mole percent of diacid residues in the polyester composition;
(b) a glycol component comprising 97 to 100 mole percent of residues of ethylene glycol, 1,4-cyclohexanedimethanol, diethylene glycol, neopentyl glycol or mixtures thereof, based on the total mole percent of glycol residues in the polyester composition; and
(c) 100 to 2,000 ppm of a fluoropolymer processing additive, based on the total weight of the polyester composition.

### BRIEF DESCRIPTION OF THE DRAWINGS

FIG. 1 is a graph showing the melt viscosity of PES 1 at 200° C. and 220° C. and various shear rates compared to the melt viscosity of PVC.

FIG. 2 is a graph showing the melt viscosity of PES 2 at 200° C. and 220° C. and various shear rates compared to the melt viscosity of PES 1 and PVC at 200° C.

FIG. 3 is a graph showing the melt viscosity of PES 3 at 200° C. and various shear rates compared to the melt viscosity of PES 1 and PVC at 200° C.

FIG. 4 is a graph showing the melt viscosity of PES 4 at 200° C. and 220° C. and various shear rates compared to the melt viscosity of PES 1 and PVC at 200° C.

FIG. 5 is a graph showing the melt viscosity of PES 5 and 6 at 200° C. and various shear rates compared to the melt viscosity of PES 1 and PVC at 200° C.

FIG. 6 is a graph of stress as a function of elongation with increasing stretching rate or melt strength.

FIG. 7 is a graph showing the shrinkage percentage in the transverse direction of several double bubble blown shrink films at various temperatures.

### DETAILED DESCRIPTION OF THE INVENTION

It has been surprisingly discovered that certain polyester compositions can be modified with an additive to make their zero-shear viscosity and degree of shear thinning comparable to those of PVC, thereby rendering the polyesters a suitable drop-in replacement for PVC in existing PVC blown film lines.

The polyester compositions suitable for use in the invention include those having an inherent viscosity (IV) of at least 0.60 dl/g. In one embodiment, the polyester compositions have an IV of 0.60 dl/g to 0.90 dl/g. In another embodiment, the polyester compositions have an IV of 0.60 dl/g to 0.80 dl/g.

The polyester compositions typically comprise:

(a) a diacid component comprising 97 to 100 mole percent of residues of terephthalic acid, naphthalenedicarboxylic acid, isophthalic acid or mixtures thereof, based on the total mole percent of diacid residues in the polyester composition; and

(b) a glycol component comprising 97 to 100 mole percent of residues of ethylene glycol, 1,4-cyclohexanedimethanol, diethylene glycol, neopentyl glycol or mixtures thereof, based on the total mole percent of glycol residues in the polyester composition.

In one embodiment, the glycol component comprises 40 to 70 mole percent of the residues of 1,4-cyclohexanedimethanol (CDHM). In another embodiment, the glycol component comprises 10 to 20 mole percent of the residues of CHDM. In another embodiment, the glycol component comprises 21 to 39 mole percent of the residues of CHDM. Other concentration ranges of the CHDM residues, within these general ranges, are also contemplated within the scope of this invention.

The polyester compositions used in the present invention typically can be prepared from dicarboxylic acids and diols, which react in substantially equal proportions and are incorporated into the polyester polymer as their corresponding residues. The polyester compositions of the present invention, therefore, can contain substantially equal molar proportions of acid residues (100 mole %) and diol residues (100 mole %) such that the total moles of repeating units is equal to 100 mole %.

The term “polyester,” as used herein, is intended to include “copolyesters.”

The term “residue,” as used herein, means any organic structure incorporated into a polymer through a polycondensation and/or an esterification reaction from the corresponding monomer. Thus, for example, the dicarboxylic acid residues may be derived from a dicarboxylic acid monomer or its associated acid halides, esters, salts, anhydrides, or mixtures thereof. Therefore, reference to a dicarboxylic acid is intended to include the dicarboxylic acid itself and any derivative of the dicarboxylic acid, including its associated isomers, acid halides, esters, half-esters, salts, half-salts, anhydrides, mixed anhydrides, and mixtures thereof, useful in a reaction with a diol to make a polyester. Examples of esters of the dicarboxylic acids useful in this invention include the dimethyl, dipropyl, diisopropyl, dibutyl, diphenyl, etc.

For example, the term “terephthalic acid” is intended to include terephthalic acid itself as well as any derivative of terephthalic acid, including its associated isomers, acid halides, esters, half-esters, salts, half-salts, anhydrides, mixed anhydrides, and mixtures thereof, useful in a reaction with a diol to make a polyester.

The diacid component of the polyester compositions may be substituted with up to 3 mol % of other aromatic dicarboxylic acids. Examples of suitable other aromatic dicarboxylic acids include 4,4′-biphenyldicarboxylic acid; 4,4′-oxydibenzoic acid; and trans-4,4′-stilbenedicarboxylic acid. In addition, the diacid component may be substituted with aliphatic or cycloaliphatic dicarboxylic acids containing 6 to 12 carbon atoms such as succinic, glutaric, adipic, sebacic, suberic, azelaic, decanedicarboxylic, and dodecanedicarboxylic acids.

The CHDM may be cis, trans, or a mixture of the two.

The glycol component of the polyester compositions may contain up to 3 mol % of another glycol containing 3 to 16 carbon atoms. Examples of suitable other glycols include 1,2-propanediol, 1,3-propanediol, 1,4-butanediol, 1,6-hexanediol, and p-xylene glycol. The polyester may also be modified with polyethylene glycols or polytetramethylene glycols.

The polyester compositions may be prepared by methods known in the art, such as those described in U.S. Pat. No. 2,465,319 and U.S. Pat. No. 3,047,539. These polyester compositions are also available commercially.

According to the invention, these polyester compositions are modified with an additive to make their zero-shear viscosity and degree of shear thinning comparable to those of PVC. Such additives include branching agents and fluoropolymer processing additives.

Branching agents useful in the context of the invention can be ones that provide branching in the acid unit portion of the polyester, or in the glycol unit portion, or it can be a hybrid. Illustrative of such branching agents are compounds comprising at least three functional groups selected from hydroxyl, carboxyl, carboxylic anhydride, and mixtures thereof. Examples include tri- or tetra-carboxylic acids and their corresponding anhydrides, such as trimesic acid, pyromellitic acid and lower alkyl esters thereof and the like, and tetrols such as pentaerythritol. Also triols such as trimethylolpropane or dihydroxy carboxylic acids and hydroxydicarboxylic acids and derivatives, such as dimethyl hydroxy terephthalate, and the like are useful within the context of this invention. Trimellitic acid or anhydride is a preferred branching agent.

These branching agents may be added directly to the polyester either during or after their preparation, or blended with the polyester in the form of a concentrate as described in U.S. Pat. Nos. 5,654,347 and 5,696,176. The branching agents may used in an amount ranging from 0.05 to 1.5 weight percent, based on the total weight of the polyester composition.

Fluoropolymer processing additives suitable for use in the invention include Dynamar™ FX 5914 offered by Dyneon (a 3M company). The fluoropolymer processing additive may be used in an amount ranging from 100 to 2,000 ppm, based on the total weight of the polyester composition. The additive may be incorporated into the polyester composition according to techniques known in the industry.

The branching agents and fluoropolymer processing additives may be used individually or in combination with each other.

The polyester compositions may also comprise 0.01 to 25 weight percent of at least one other additive such as colorants, dyes, release agents, flame retardants, plasticizers, nucleating agents, UV light stabilizers, fillers, processing aids, and reinforcing materials such as glass fibers.

The polyester compositions according to the invention may be formed into a blown film using equipment and conditions typically used in making PVC blown film such as in a Rulli or Macchi blown film line.

Typically, in a blown film process, a polymer is extruded through an annular die and exits as a thin-walled molten tube. The tube is inflated internally by air that is supplied through an inner mandrel of the die to form a film bubble. Air can also be blown on the outside of the bubble to cool it down. The film bubble can then be collapsed and (1) wound as a tube for storage, (2) slit along one or both sides to form individual films, and/or (3) for application as a shrink film, reblown for a second or third time to achieve a desired thickness and shrinkage. The thickness and shrinkage properties of the film can be controlled by uni- or biaxially orienting the film.

The amount of film orientation in the transverse direction (TD) is controlled by the amount the film is inflated, which is characterized by the blow up ratio (BUR). And the amount of film orientation in the machine direction is controlled by the draw down ratio (DDR). BUR and DDR are defined by equations (1) and (2), respectively:

BUR=D_{b}/D_{d}=2×layflat width/(D_{d}×π) (1)

DDR=t_{d}/(t_{f}×BUR) (2)

where D_{b} is the diameter of the bubble, D_{d} is the diameter of the die, t_{d} is the die gap, and t_{f} is the thickness of the film.

Thus, in one aspect, the present invention relates to a blown film comprising at least one layer made from the polyester compositions described herein. In one embodiment, the polyester compositions for making blown film according to the invention have a zero-shear viscosity of greater than 60,000 poise (P) at 200° C. In another embodiment, the zero-shear viscosity is greater than 100,000 P at 200° C.

In one embodiment, the polyester compositions for making blown film according to the invention have a melt viscosity of less than 40,000 P at 200° C. and 100 s⁻¹. In another embodiment, the melt viscosity is less than 30,000 P at 200° C. and 100 s⁻¹.

In one embodiment, the blown film according to the invention is a shrink film made by a double- or triple-bubble blown film process. The shrink film can have a shrinkage in the TD direction of greater than 20% when placed in a 95° C. water bath for 10 seconds. The shrink film can also have a shrinkage in the TD direction of greater than 40% when placed in a 95° C. water bath for 10 seconds. Alternatively, the shrink film can have a shrinkage in the TD direction of less than 40% when placed in a 95° C. water bath for 10 seconds. The shrinkages apply to polyester compositions having a range of glycol components, for example, wherein the glycol component comprises 40 to 70 mole percent of the residues of 1,4-cyclohexanedimethanol (CDHM), or 10 to 20 mole percent of the residues of CHDM or 21 to 39 mole percent of the residues of CHDM or 97 to 100 mole percent of residues of ethylene glycol, 1,4-cyclohexanedimethanol, diethylene glycol, neopentyl glycol or mixtures thereof, based on the total mole percent of glycol residues in the copolyester compositions.

The shrink film according to the invention can have a high on-set shrinkage temperature such as 70° C. or greater.

In another aspect, the invention relates to a method of making a blown film using the polyester compositions described herein. The method generally includes the steps of extruding the polyester composition through an annular die to form a tube, and inflating the inside of the tube with air to form a film bubble. As mentioned above, the film bubble can be collapsed and reblown a second or third time to make shrink film.

This invention can be further illustrated by the following working examples, although it should be understood that these examples are included merely for purposes of illustration and are not intended to limit the scope of the invention.

### EXAMPLES

### Measurement Methods

The inherent viscosity (IV) of the polyesters was determined in a solvent of 60/40 (wt/wt) phenol/1,1,2,2-tetrachloroethane at a concentration of 0.5 g/100 ml at 25° C., and is reported in units of dL/g.

Melt viscosity of the polyester composition was measured by drying polyester pellets at 60° C. for 2 days, weighing 2 g of pellets and placing them in the chamber of RDA Rheometrics Dynamic Analyzer equipped with a plate-and-plate rheometer, heating up the chamber to the desired temperature and measuring the viscosity (in Poise) from 1 to 400 rad/s.

Film shrinkage measurement was performed by cutting the film into 100 mm×100 mm square samples, setting the water temperature to the desired temperature ranging from 65° C. to 95° C., dipping the sample in the water bath for 10 seconds and measuring the dimensional changes in both the TD and MD directions.

### Polyester Compositions

The composition of the polyesters tested in the examples below are set forth in Table 1. In Table 1, TPA is terephthalic acid, EG is ethylene glycol, CHDM is 1,4-cyclohexanedimethanol, and TMA is trimellitic anhydride.

TABLE 1
Polyester Compositions

| Composition | PES 1 | PES 2 | PES 3 | PES 4 | PES 5 | PES 6 | PES 7 |
|---|---|---|---|---|---|---|---|
| TPA (mol %) | 100 | 100 | 100 | 100 | 100 | 100 | 100 |
| EG (mol %) | 69 | 69 | 69 | 50 | 80 | 80 | 31 |
| CHDM (mol %) | 31 | 31 | 31 | 50 | 20 | 20 | 69 |
| TMA (wt %) | 0 | 0.18 | 0.20 | 0.18 | 0.30 | 0.30 | 0 |
| IV (dL/g) | 0.75 | 0.76 | 0.65 | 0.76 | 0.68 | 0.73 | 0.73 |

### Melt Viscosity at Various Shear Rates and Temperatures

The melt viscosity of PVC and PES 1-6 at various shear rates was measured at 200° C. and 220° C. The results are shown in Table 2.

TABLE 2
Melt Viscosity versus Shear Rate

| | Temp. | Shear Rate (rad/s) | | | | | |
|---|---|---|---|---|---|---|---|
| Comp. | (° C.) | 1 | 4 | 10 | 40 | 100 | 400 |
| PVC | 200 | 128,270 | 76,964 | 53,358 | 28,701 | 17,750 | 7,198 |
| PES 1 | 200 | 107,840 | 94,385 | 80,642 | 54,621 | 37,354 | 18,413 |
| PES 1 | 220 | 49,302 | 44,635 | 39,581 | 29,180 | 21,506 | 11,936 |
| PES 2 | 200 | 189,450 | 130,050 | 95,146 | 54,703 | 35,327 | 16,882 |
| PES 2 | 220 | 90,481 | 67,638 | 52,234 | 32,396 | 22,129 | 11,566 |
| PES 3 | 200 | 65,468 | 54,410 | 44,802 | 29,994 | 21,296 | 11,542 |
| PES 4 | 200 | 185,300 | 127,740 | 93,929 | 54,218 | 35,148 | 16,928 |
| PES 4 | 220 | 90,298 | 67,215 | 52,042 | 32,342 | 22,034 | 11,437 |
| PES 5 | 200 | 113,780 | 79,331 | 58,605 | 34,256 | 22,711 | 11,491 |
| PES 6 | 200 | 165,890 | 107,240 | 75,712 | 41,768 | 26,802 | 13,018 |

### Example 1 (Comparative)

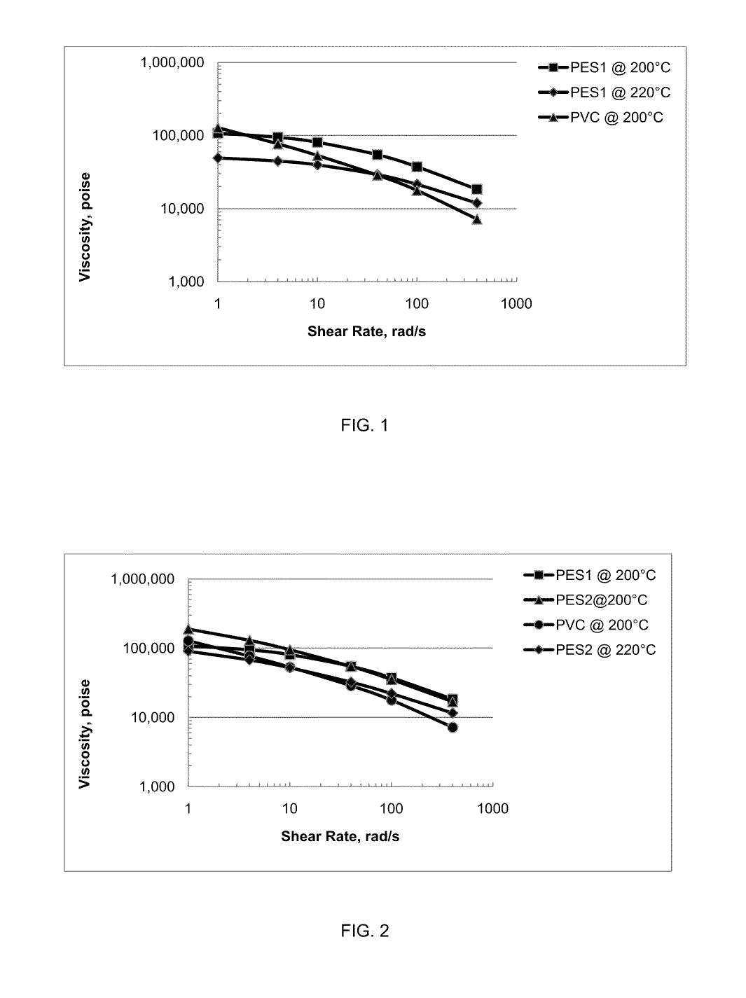

The melt viscosity of PES 1 at 200° C. and 220° C. and various shear rates was measured and compared with the melt viscosity of PVC. This comparison is shown graphically in FIG. 1.

As seen in FIG. 1, PES 1 can maintain a high zero-shear viscosity (shear rate at 1 rad/s), but it also has a high shear viscosity at 100 s⁻¹ if it is processed at the same temperature as PVC, i.e., at 200° C.

It has been reported that current PVC machines cannot melt pump PES 1 at this temperature due to excessive pressure developed in the extruder. There were a lot of defects such as gels in the film due to poor melting at this temperature.

PES 1 can be extruded at 220° C. where its viscosity matches PVC's viscosity nicely at 100 s⁻¹ shear rate. Unfortunately, the zero-shear viscosity of PES 1 at this temperature decreased about 50%, which makes bubble formation much less stable and profile control very difficult.

### Example 2

To overcome the dilemma of PES 1 in Example 1, 0.18 wt % of TMA was added to the same polyester composition as PES 1 to form PES 2. The IV of PES 2 was maintained the same as PES 1.

The melt viscosity of PES 2 at 200° C. and 220° C. and various shear rates was measured and compared with the melt viscosity of PES 1 and PVC at 200° C. This comparison is shown graphically in FIG. 2.

As seen in FIG. 2, PES 2 still has a much higher viscosity if it is extruded at 200° C., even though it has a much better zero-shear viscosity.

By increasing the processing temperature to 220° C., the melt viscosity of PES 2 is now similar to PVC's at 100 s⁻¹ shear rate while the zero-shear viscosity remains high and close to PVC's as well.

PES 2, therefore, can be used as a PVC replacement in blown film applications with a simple adjustment of increasing the extrusion temperature in the extruder barrels.

### Example 3

For a straight drop-in replacement of PVC without any machine adjustment, the same polyester composition with 0.2 wt % of TMA and a lower IV is recommended.

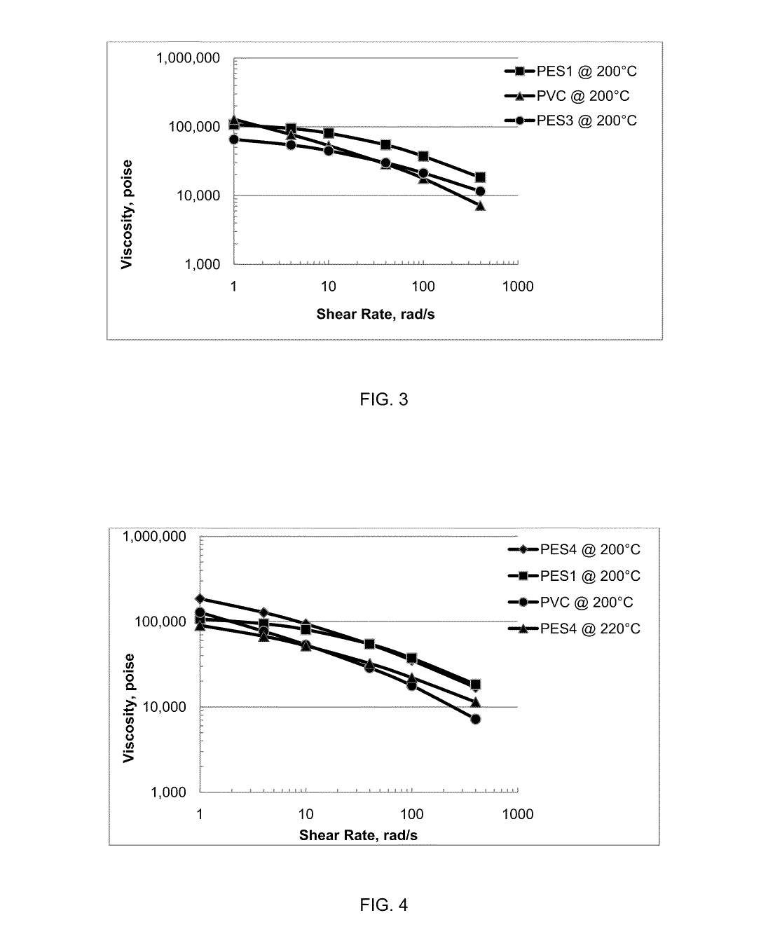

The melt viscosity of PES 3 at 200° C. and various shear rates was measured and compared with the melt viscosity of PES 1 and PVC at 200° C. This comparison is shown graphically in FIG. 3.

As seen in FIG. 3, PES 3 has similar viscosity as PVC at 100 s⁻¹ shear rate at 200° C. The zero-shear viscosity was not as high, but was much better than that of PES 1 at 220° C. as shown in FIG. 1.

### Example 4

Shrink films, in general, are heat sensitive, but some shrink films have higher on-set shrinkage temperatures than others. Shrink films with a higher on-set shrinkage temperature are needed to prevent label distortion in secondary, case-packaging using polyolefin overwrapping film with high activation heat. High on-set shrink films are also suitable for hot-fill labeling where labels could be stuck together due to residual heat in the bottles if low on-set shrink films are used.

PES 4 is a good candidate for such an application. PES 7 can be a good candidate too if it is branched.

The melt viscosity of PES 4 at 200° C. and 220° C. and various shear rates was measured and compared with the melt viscosity of PES 1 and PVC at 200° C. This comparison is shown graphically in FIG. 4.

As seen in FIG. 4, PES 4 cannot be processed at 200° C. due to high melt viscosity. But by increasing the melt temperature by 20° C. (similar to PES 2), PES 4 can be extruded with a viscosity comparable to PVC's and with a good zero-shear viscosity (melt strength).

### Example 5

For lower overall shrinkage and more compatibility with PET recycle streams, a polyester label with less CHDM mole % should be used. PES 5 and 6 have 20 mole % CHDM with 0.30 wt % of TMA.

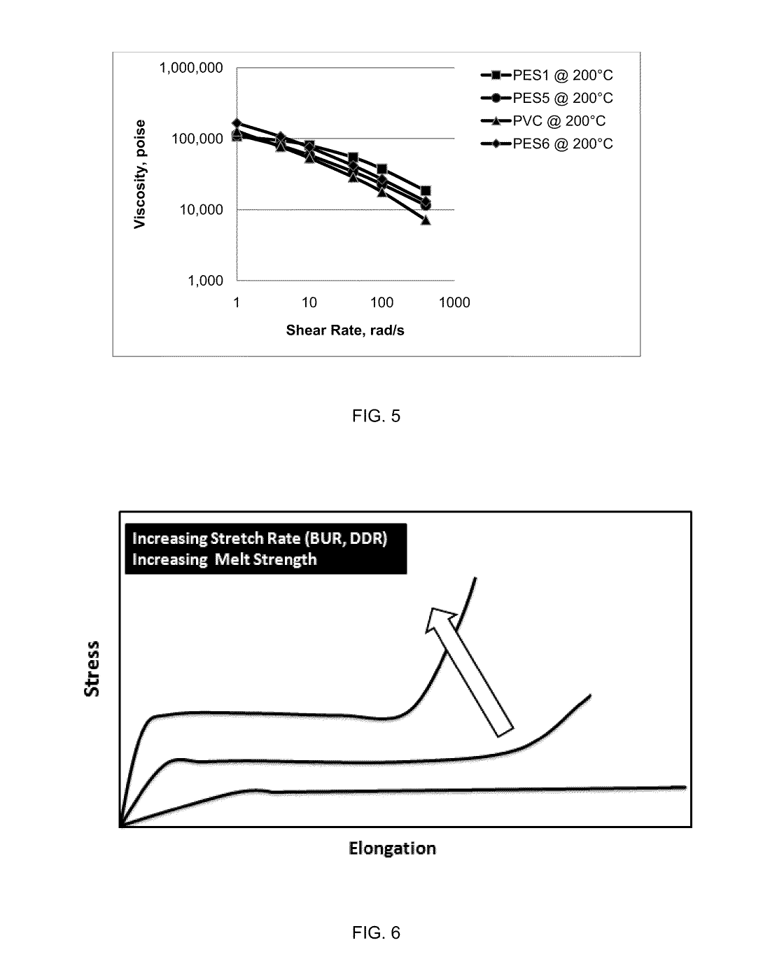

The melt viscosity of PES 5 and 6 at 200° C. and various shear rates were measured and compared with the melt viscosity of PES 1 and PVC at 200° C. This comparison is shown graphically in FIG. 5.

As seen in FIG. 5, the low IV PES 5 mimics PVC relatively well in the melt viscosity curve at 200° C. The high IV PES 6 polymer will have to be run at 220° C. for a similar melt viscosity at 100 s⁻¹ shear rate.

### Example 6 (Prophetic)

It is well known that, to achieve a better thickness profile in any stretching operation, the film should have a high IV and be oriented as fast and as cold as possible. The idea is to take advantage of the self-leveling effect with minimum film elongation as illustrated in FIG. 6 where the top curve experiences self-leveling at the second infection point while the bottom curve has no observable self-leveling.

The steep upswing on the top curve indicates that rapid resistance develops in the stretched region. This mechanism propels smooth stretching, thereby providing an even thickness profile across the entire web across the flat film or the circumference around the tubular film.

In blown film, the BUR/DDR, temperature, and IV of the polymer are normally optimized already. A simple way to obtain higher IV equivalent polymer with higher shear thinning is by branching the polymer of the same composition. The branched polymer will provide not just easy processing, but also high melt strength, which in turn provides a more stable bubble, a better self-leveling effect, and hence a better thickness profile.

### Example 7

Typical blown PVC shrink film can have a TD shrinkage of 30% to 60%, depending on formulations and stretching conditions. Polyester shrink film, on the other hand, is capable of delivering up to 80% shrinkage in a TDO stretching process.

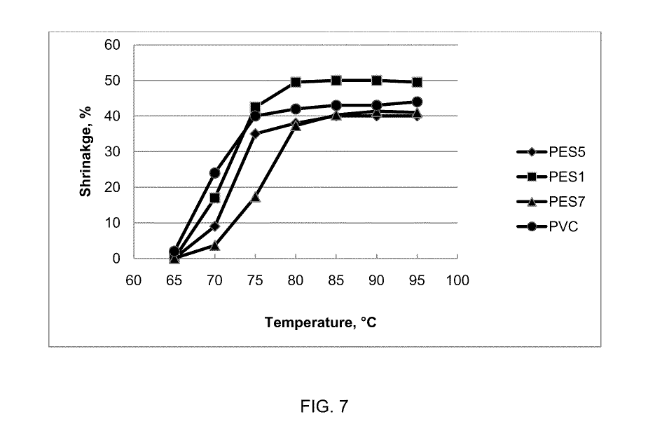

PES 1, 5, and 7 and PVC were made into shrink film using a double-bubble blown film process. Their shrinkage in the TD direction was measured after being dipped in a water bath having a temperature ranging from 65° C. to 95° C. for 10 seconds. The results are shown in Table 3 and graphically depicted in FIG. 7.

As seen in FIG. 7, in a double-bubble blown film process, polyesters of various CHDM content can provide a wide spectrum of shrinkage for shrink film packaging.

TABLE 3
TD Shrinkage of Various Double-Bubble Shrink Films

| | |
|---|---|
| Temp. | Shrinkage in TD Direction (%) |

| (° C.) | PES 5 | PES 1 | PES 7 | PVC |
|---|---|---|---|---|
| 65 | 0 | 0 | 0 | 2 |
| 70 | 9 | 17 | 4 | 24 |
| 75 | 35 | 43 | 17 | 40 |
| 80 | 38 | 50 | 37 | 42 |
| 85 | 40 | 50 | 40 | 43 |
| 90 | 40 | 50 | 41 | 43 |
| 95 | 40 | 50 | 41 | 44 |

### Example 8

In addition to branching technology, there is a free-flowing fluoropolymer processing additive (PPA), Dynamar™ FX 5914 by Dyneon (a 3M company), that can be used to make polyester blown films. A concentrate of 2 weight % of Dynamar™ FX 5914 in a PETG (10 mole % CHDM, 10 mole ° A) diethylene glycol and 70 mole % ethylene glycol and 100 mole % TPA) was blended in to the PETG to provide Dynamar™ FX 5914 at concentrations of 200, 400 and 600 ppm by weight. The films made had high haze.

The invention has been described in detail with particular reference to preferred embodiments thereof, but it will be understood that variations and modifications can be effected within the spirit and scope of the invention.

We claim:

1. A blown film comprising at least one layer made from a polyester composition having an inherent viscosity of at least 0.60 dL/g and comprising:
(a) a diacid component comprising 97 to 100 mole percent of residues of terephthalic acid, naphthalenedicarboxylic acid, isophthalic acid or mixtures thereof, based on the total mole percent of diacid residues in the polyester composition;
(b) a glycol component comprising 97 to 100 mole percent of residues of ethylene glycol, 1,4-cyclohexanedimethanol, diethylene glycol, neopentyl glycol or mixtures thereof, based on the total mole percent of glycol residues in the polyester composition; and
(c) 0.05 to 1.5 weight percent of a branching agent comprising at least three functional groups selected from hydroxyl, carboxyl, carboxylic anhydride, and mixtures thereof, based on the total weight of the polyester composition.

2. The blown film according to claim 1, wherein the polyester composition has a zero-shear viscosity of greater than 60 kP at 200° C.

3. The blown film according to claim 1, wherein the polyester composition has a melt viscosity of less than 40 kP at 200° C. and 100 s⁻¹.

4. The blown film according to claim 1, wherein the blown film is a shrink film made by a double-bubble or a triple-bubble blown film process.

5. The blown film according to claim 4, which has a shrinkage in the transverse direction of greater than 20% when placed in a 95° C. water bath for 10 seconds.

6. The blown film according to claim 4, wherein the glycol component comprises 40 to 70 mole percent of the residues of 1,4-cyclohexanedimenthanol.

7. The blown film according to claim 6, which has an on-set shrinkage temperature of 70° C. or greater.

8. The blown film according to claim 4, wherein the glycol component comprises 10 to 20 mole percent of the residues of 1,4-cyclohexanedimenthanol.

9. The blown film according to claim 4, wherein the glycol component comprises 21 to 39 mole percent of the residues of 1,4-cyclohexanedimenthanol.

10. The blown film according to claim 4, which has a shrinkage in the transverse direction of greater than 40% when placed in a 95° C. water bath for 10 seconds.

11. The blown film according to claim 8, which has a shrinkage in the transverse direction of greater than 40% when placed in a 95° C. water bath for 10 seconds.

12. The blown film according to claim 9, which has a shrinkage in the transverse direction of greater than 40% when placed in a 95° C. water bath for 10 seconds.

13. The blown film according to claim 1, wherein the branching agent is trimellitic acid or anhydride.

14. A method of making a blown film, said method comprising:
(a) extruding a polyester composition through an annular die to form a tube; and
(b) inflating the inside of the tube with air to form a film bubble,
wherein the polyester composition has an inherent viscosity of at least 0.60 dl/g and comprises:
(i) a diacid component comprising 97 to 100 mole percent of residues of terephthalic acid, naphthalenedicarboxylic acid, isophthalic acid or mixtures thereof, based on the total mole percent of diacid residues in the polyester composition;
(ii) a glycol component comprising 97 to 100 mole percent of residues of ethylene glycol, 1,4-cyclohexanedimethanol, diethylene glycol, neopentyl glycol or mixtures thereof, based on the total mole percent of glycol residues in the polyester composition; and
(iii) 0.05 to 1.5 weight percent of a branching agent comprising at least three functional groups selected from hydroxyl, carboxyl, carboxylic anhydride, and mixtures thereof, based on the total weight of the polyester composition.

15. The method according to claim 14, wherein the branching agent is trimellitic acid or anhydride.
